(19) United States
(12) Patent Application Publication
(10) Pub. No.: US 2009/0042481 A1
(43) Pub. Date: Feb. 12, 2009

(54) METHOD OF CALIBRATING OR COMPENSATING SENSOR FOR MEASURING PROPERTY OF A TARGET SURFACE

(76) Inventors: Rashid A. Mavliev, Campbell, CA (US); Gerald John Alonzo, Los Gatos, CA (US); Simon Yavelberg, Cupertino, CA (US)

Correspondence Address: PATTERSON & SHERIDAN, LLP - - APPM/TX, 3040 POST OAK BOULEVARD, SUITE 1500, HOUSTON, TX, 77056, US

(21) Appl. No.: 11/835,624

(22) Filed: Aug. 8, 2007

(51) Int. Cl. B24B 49/12; G01B 11/30

(52) U.S. Cl. 451/8; 356/600; 356/612; 451/6

(57) ABSTRACT

A method of calibrating or compensating a sensor for measuring property of target surface is provided. In one embodiment, a liquid reference surface is formed on a platen. A sensor is used to measure a feature property of the reference surface. The measured feature property of the reference surface may be used to calibrate the sensor. Further, the sensor is used to measure the feature property of a polishing pad. The measured feature property of the reference surface may be used to compensate the measured feature property of the polishing pad.

### BACKGROUND OF THE INVENTION

1. Field of the Invention

The present invention relates to a method for measuring a property of a target surface, and more particularly to the method of calibrating or compensating a sensor configured to measure the property of the target surface.

2. Description of Related Art

In the fabrication of integrated circuits (ICs) and display elements, chemical mechanical planarization (CMP) and electrochemical mechanical planarization (ECMP) are typically used to planarize the surface topography of a substrate for subsequent etching and deposition processes. A CMP polishing pad is one of most critical parts which define the success of substrate polishing process. During CMP, the surface of the substrate to be planarized is brought into contact with the surface of the CMP polishing pad, and the substrate and the CMP polishing pad are rotated and translated relative to each other with a polishing processing solution supplied to polish the substrate. After the CMP process is performed for a certain period of time, the polishing surface of the CMP polishing pad becomes uneven or glazed due to accumulations of processing solution by-products and/or material removed from the substrate and/or the polishing pad, thus reducing the polishing rate and increasing the likelihood that the substrate can be scratched during polishing. Therefore, it is desired to monitor the initial pad properties of the CMP polishing pad as well as the transition ones during pad lifetime. In ECMP, polishing quality is also sensitive to the surface properties of the polishing pads since in many cases the top surface of the polishing pad also provides electrical contact to the substrates being polished. Therefore, pad property monitoring is also desired in ECMP processes.

In general, a pad metrology system with various sensors, such as an optical sensor and a distance sensor, are used to measure the properties of the CMP polishing pad especially related to surface profile, for example surface flatness. For assuring the measurement accuracy, the pad metrology system has to undergo calibration periodically, or the measurement data therefrom has to be compensated. However, how to efficiently and timely perform metrology system calibration or compensation has been one of the problems associated with the pad metrology on tool.

Therefore, there is a need for a method of efficiently calibrating a sensor or compensating output of a sensor configured to measure the property of the target surface, e.g. a surface of a polishing pad.

### SUMMARY OF THE INVENTION

One embodiment provides a method for calibrating a sensor configured to measure a featured property of a target surface. The method comprises providing a reference surface formed from a liquid, measuring the featured property of the reference surface using the sensor, and calibrating the senor using the measured featured property of the reference surface.

Another embodiment provides a method for measuring a property of a polishing pad disposed on a platen. The method comprises: providing a reference surface formed from a liquid, obtaining a reference value of the property by measuring the liquid surface using a sensor, measuring the property of the polishing pad using the sensor, and correcting the measured property of the polishing pad using the reference value.

Yet another embodiment provides a method for processing a semiconductor substrate. The method comprises providing a platen configured to support a polishing pad thereon, providing a sensor disposed above the platen and configured to measure a surface feature of the polishing pad on the platen, forming a liquid surface on the platen, measuring the surface feature of the liquid surface using the sensor, and calibrating the sensor using measured surface of the liquid surface.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1A schematically illustrates a surface measuring system in a calibration mode in accordance with one embodiment of the present invention.

FIG. 1B schematically illustrates a surface profile measurement of a reference surface.

FIG. 1C schematically illustrates a surface profile correction obtained from the calibration process.

FIG. 2A schematically illustrates the surface measuring system of FIG. 1A in a surface measuring mode.

FIG. 2B schematically illustrates a raw surface profile measurement of a target surface.

FIG. 2C schematically illustrates the surface profile measurement of the target surface after correction.

FIG. 3A is a schematic top view showing a pad metrology system mounted on a polisher cross for a CMP or ECMP process.

FIG. 3B is a schematic front view showing the pad metrology system mounted on the polisher cross.

FIG. 4 is a flow chart showing a method for calibrating a sensor configured to measure a featured property of a target surface according to an embodiment of the present invention.

FIG. 5 is a flow chart showing a method for measuring a property of a polishing pad disposed on a platen according to another embodiment of the present invention.

FIG. 6 is a graph showing the cross vertical compensation data measured from a liquid reference surface.

FIG. 7 schematically illustrates a liquid reference surface in accordance with another embodiment of the present invention.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Embodiments of the present invention are generally directed to using a liquid surface as a reference surface for measuring surface properties, such as flatness, surface profile, local surface profile, roughness, and other properties. Particularly, embodiments of the present invention relate to monitoring and calibrating of surface properties, such as surface profile, flatness, and other properties related to surface flatness such as local profiles, of a polishing pad surface. Embodiments of the present invention comprise using the property of the reference surface measured by a sensor to calibrate the sensor or to compensate the measured property of the surface.

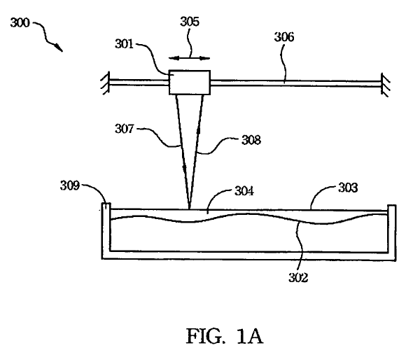

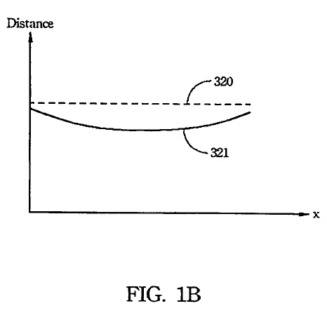

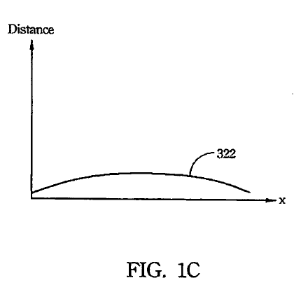

FIG. 1A schematically illustrates a surface measuring system 300 in a calibration mode in accordance with one embodiment of the present invention. The surface measuring system 300 comprises a sensor 301 movably positioned above a target surface 302 to be measured. The sensor 301 is configured to measure one or more surface properties of the target surface 302. The sensor 301 may comprise a light source, such as a laser source, configured to measure surface properties by projecting a light beam, such as a laser beam, to a target surface, and an optical sensor, such as a laser sensor and a charged coupled device (CCD) camera, configured for receiving and measuring the light beam reflected from the target surface.

In one embodiment, a relative movement, as shown by arrow 305, between the sensor 301 and any target surfaces is provided during processing. System errors, such as those caused by the means to provide relative movements 305, mounting structures of the sensor 301 and target surfaces, and measuring circuits, are generally unavoidable during measurement. Therefore, it is necessary to calibrate the sensor 301 to assure accurate measurement. One way to calibrate a sensor is to form a reference surface in a position approximate a measuring position of the target surface 302, and to measure the reference surface, which properties are considered known, and compare the measurement from the sensor to the known properties of the reference surface. The difference between the measurement and known value of the reference surface is generally used to make correction to the sensor measurement, either by correcting or compensating the measurement to the sensor or physically calibrating the sensor. In cases, when the difference becomes large enough, physical corrections and calibrations to the sensor, such as adjusting mounting structures, may be called for. Calibrations may be performed periodically. Embodiments of the present invention provide convenient and accurate reference surface.

As shown in FIG. 1A, the sensor 301 is configured to measure a target surface 302 disposed below the sensor 301. In one embodiment, a liquid surface 303 may be used as a reference surface to the sensor 301 for calibration. The liquid surface 303 provides a quick and convenient way to calibrating the sensor 301 because the profile of the liquid surface 303 may be considered horizontal or flat due to gravity. Liquid surfaces are easy to obtain and do not require high precision manufacturing as a solid reference surface would, therefore, provides convenience and reduces cost.

In one embodiment, the liquid surface 303 may be generated by completely covering the target surface 302 with a light scattering liquid 304. A lip 309 may be provided around the target surface 302 to facilitate the formation of the liquid surface 303. During calibration, the sensor 301 is configured to measure the reference surface 303. In one embodiment, a laser beam 307 may be projected to the reference surface 303 and a reflected beam 308 is measured by the sensor 301.

FIG. 1A schematically illustrates a track 306 along which the sensor 301 may be moved relative to the reference surface 303 so that the sensor 301 may perform measurements across the reference surface 303. It should be noted, the relative movement between the reference surface 303 and the sensor 301 may be provided by many means depending on the actual environment of the system.

FIG. 1B schematically illustrates a surface profile measurement 321 of the reference surface 303, which has a known profile 320. A correction profile may be obtained from the difference between the known profile 320 and the surface profile measurement 321.

FIG. 1C schematically illustrates a surface profile correction 322 obtained from the calibration process, wherein the addition of the surface profile correction 322 to the surface profile measurement 321 of FIG. 1B will generate the known profile 320 of FIG. 1B.

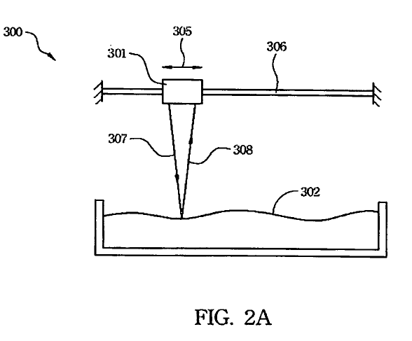

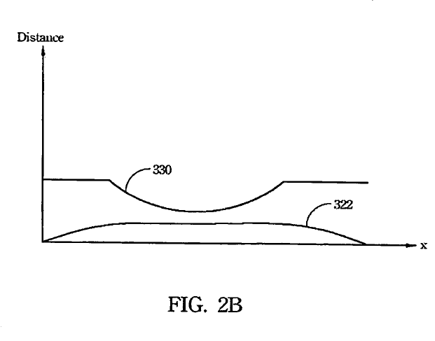

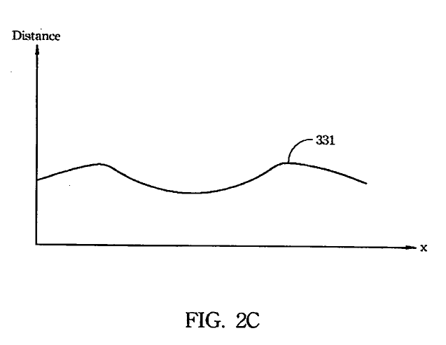

FIG. 2A schematically illustrates the surface measuring system of FIG. 1A in a surface measuring mode. In the surface measuring mode, the sensor 301 is configured to measure the target surface 302. In one embodiment, the light scattering liquid 304 of FIG. 1A is completely removed after the calibration mode is performed. In one embodiment, the laser beam 307 may be projected to the target surface 302 and the reflected beam 308 is measured by the sensor 301. FIG. 2A schematically illustrates the track 306 along which the sensor 301 may be moved relative to the reference surface 303 so that the sensor 301 may perform measurements across the target surface 302. It should be noted, the relative movement between the target surface 302 and the sensor 301 may be provided by any suitable means depending on the actual environment of the system. FIG. 2B schematically illustrates a raw surface profile measurement 330 of the target surface 302. The raw surface profile measurement 330 can be corrected (compensated) by the surface profile correction 322 described above, thereby obtaining an accurate measurement of the target surface 302. FIG. 2C schematically illustrates a surface profile measurement 331 of the target surface 302 after correction using the surface profile correction 322. The surface profile measurement 331 (accurate measurement) of the target surface 302 can be obtained by adding the surface profile correction 322 to the raw surface profile measurement 330, also referring to FIG. 2B.

As discussed earlier, a light scattering liquid may be used to form a reference surface for an optical sensor. Different liquid may be used for forming a reference surface for different sensors. In one embodiment, the light scattering liquid may comprise particles. In one embodiment, a magnetic liquid, a liquid with particles suspended therein, may be used to form a reference surface for magnetic sensors. Liquid reference surfaces may be used to calibrate and monitor sensors for measuring properties of polishing pads in a CMP or ECMP system.

Even though the reference surface 303 shown in FIG. 1A is formed above the target surface 302, the reference surface 303 may be formed independently from the target surface 302.

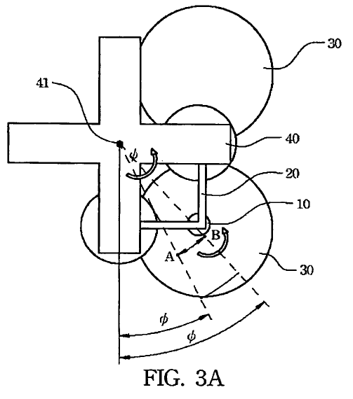

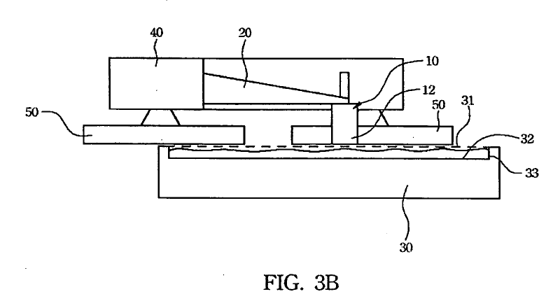

Referring to FIG. 3A and FIG. 3B, FIG. 3A and FIG. 3B are schematic top and front views showing a pad metrology system 10 mounted on a polisher cross 40 for CMP or ECMP process. The polishing cross 40 provides radial motion to a polishing head 50 so that the polishing head 50 are movable among platens 30. The pad metrology system 10 comprises a sensor 12 mounted on a support 20 connected to the polisher cross 40. The metrology system 10 may move relatively across the polishing platen 30 as the polisher cross 40 rotates about a central axis 41. The sensor 12 is aimed at a polishing pad 32 (shown in FIG. 3B without a reference liquid surface 31) disposed on the polishing platen 30. The sensor 12 is configured for measuring a featured property of the polishing pad 32. In one embodiment, the featured property is a surface property regarding surface profile or local profiles.

During the motion provided by the polisher cross 40, undesired movements of the sensor 12, such as vertical displacement, for example due to bearings (not shown) of the polisher cross 40, may be introduced, thus hindering the accuracy of the sensor 12. To overcome this problem, embodiments of the present invention use a reference liquid surface 31 disposed on the polishing platen 30 to calibrate the sensor 12 or compensate the data measured by the pad metrology system 10, and to verify the accuracy of the rotation of the polisher cross 40. The reference liquid surface 31 can provide a target with ideal flatness, and is preferably formed from a light scattering liquid.

When the embodiments of the present invention are applied, the polishing platen 30 with gutter 33 (as shown in FIG. 3B) can be filled with, for example, a light scattering liquid for forming a reference liquid surface 31, and then the surface map of the reference liquid surface 31 will be measured with the pad metrology system 10. Any deviation from flatness in the surface map will be attributed to imperfection of the pad metrology system 10 which will be calibrated and corrected accordingly.

Two examples are described hereinafter for explaining a method for calibrating the sensor 12 and a method for correcting and/or compensating the measured property of the polishing pad 32 disposed on the polishing platen 30. However, any other calibration or compensation method of using a liquid surface as a reference surface is also applicable to the present invention, and thus the present invention is not limited thereto.

### EXAMPLE 1

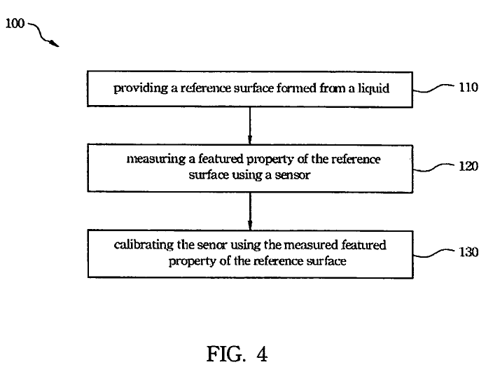

FIG. 4 is a flow chart showing a method 100 for calibrating a sensor conFigureured to measure a featured property of a target surface according to another embodiment of the present invention. The sensor may be an optical sensor such as a CCD camera, and a distance sensor. The featured property may be, for example, a surface property regarding surface profile or local profiles, and the target surface is the polishing surface of a polishing pad such as a CMP polishing pad, an ECMP polishing pad, etc.

The method 100 begins at step 110 wherein a reference surface formed from a liquid is provided. The liquid can be, for example, CMP processing solution, ECMP processing solution, a suitable suspension, or the mixtures thereof. Exemplary suspension may be a bismuth solution such as Pepto-Bismol, a creamer substitute such as Mini-Moos, milk, milk of magnesia. The species forming the reference surface are merely stated as examples, and this embodiment is not limited thereto.

The method 100 then proceeds to step 120 where the sensor, for example a CCD camera, is used to measure the featured property, such as surface profile, of the reference surface, thereby obtaining a set of compensation data with respect to the featured property, such as surface profile, of the reference surface.

The method 100 then continues to step 130 where the measured featured property of the reference surface (i.e. the set of compensation data) is used to calibrate the senor, for example, to physically adjust the position of the sensor, if necessary.

Basically, the method 100 of this embodiment uses the measured featured property of the reference surface to physically adjust or calibrate the sensor, and persons skilled in the art may determine specific adjustment for a particular sensor, and thus the steps of calibrating the sensor will not be described in detail herein.

### EXAMPLE 2

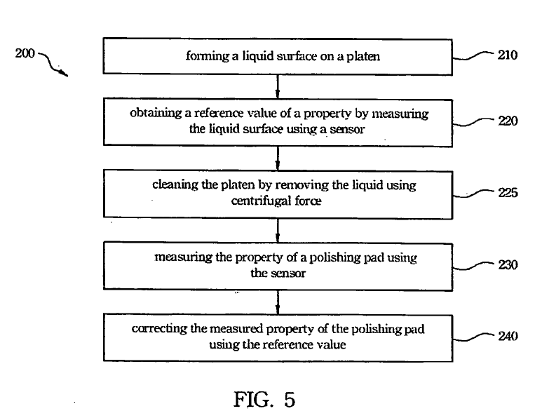

FIG. 5 is a flow chart showing a method 200 for measuring a property of a polishing pad disposed on a platen according to another embodiment of the present invention, wherein the polishing pad and the platen can be, for example, the components of CMP or ECMP equipment, and the property of the polishing pad can be, for example, a surface property regarding surface profile or local profiles.

The method 200 begins at step 210 where a liquid surface is formed on the platen, wherein the liquid surface can be formed from, for example, CMP processing solution, ECMP processing solution, or any suitable liquid, and this embodiment is not limited thereto.

The method 200 then proceeds to step 220 wherein a sensor, for example, CCD camera, is used to measure the liquid surface, thereby obtaining a reference value of the property of the liquid surface, i.e. obtaining a set of compensation data with respect to the featured property, for example surface profile, of the reference surface.

In one embodiment, the liquid surface may be formed over a polishing pad disposed on the platen. After obtaining the reference value using the liquid surface, the platen and polishing pad may be cleaned by removing the liquid used to form the liquid surface. In one embodiment, the liquid may be removed using centrifugal force generated from rotating the platen.

The method 200 then continues to step 230 wherein the sensor is used to measure the property of the polishing pad, thereby obtaining a set of raw measurement data.

In one embodiment, the reference liquid surface and the polishing pad are disposed on the platen alternately in steps 220 and 230. After step 220, the method 200 may proceed to step 225 wherein the platen is cleaned by removing the liquid using centrifugal force, thereby disposing or exposing the polishing pad on the platen. The method 200 then continues to step 240 wherein the reference value, i.e. the set of compensation data, is used to correct or compensate the measured property (the set of raw material) of the polishing pad, for example, to subtract the reference value from a raw measurement of the same point along the radius of the polishing pad.

Basically, the method 200 of this embodiment measures the corresponding points along the radius the liquid surface and that of the polishing pad surface alternately formed on the same platen, thereby respectively obtaining a set of raw measurement data of the polishing pad surface and a set of compensation data of the liquid surface, and persons skilled in the art may determine specific compensation values by comparing the set of raw measurement data and the set of compensation data, and thus the steps of determining the compensation values will not be described in detail herein.

The embodiments of the present invention may use various liquid species to form a reference surface. Hereinafter, different liquid species may be used in the following example for providing reliable compensation data that can be used for calibrating the sensor or correcting the measurement data of the polishing pad. The following example is operated in CMP or ECMP equipment shown in FIGS. 3A and 3B, but other types of equipment are also applicable to the present invention, and thus the present invention is not limited thereto.

### EXAMPLE 3

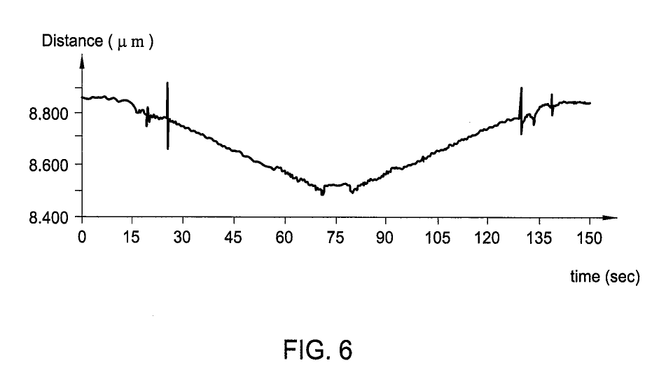

Returning to FIGS. 3A and 3B, a liquid, Pepto-Bismol (bismuth) full strength liquid in this case, is used to form a reference surface on the polisher platen 30. The sensor 12 is aimed on at a first predetermined point A of the reference surface when Ψ is 54 degree. Thereafter, the polishing cross 40 is rotated at about 0.1 degree/minute from ψ=54 degree to a second predetermined point B of the reference surface wherein ψ=63 degree and then back to ψ=54 degree. The sensor 12 measures the featured property, distance to the reference surface, at a predetermined time-step, thereby obtaining a plurality of reference property values, such as shown in FIG. 6, which is a graph showing the cross vertical compensation data measured from a reference surface formed from Pepto-Bismol full strength liquid.

Each of the reference property values can be used as compensation data for calibrating the sensor 12 or correcting the measurement data of the polishing pad to be disposed on the polishing platen 30 subsequently at a corresponding location.

According to the forgoing embodiments, the present invention has the advantages of briefly calibrating a sensor or compensating a set of measurement data by using a liquid surface as a reference surface; and allowing to calibrate the pad metrology system and to correct the measurement data directly on tool in operational conditions, thus efficiently and timely perform metrology system calibration or compensation.

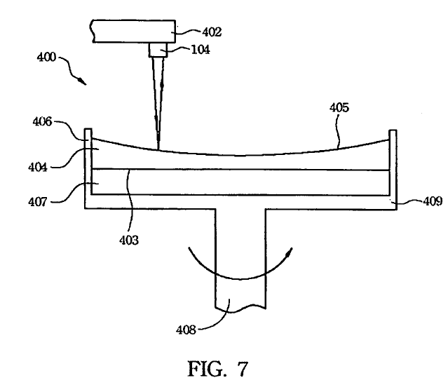

Embodiments of the present invention may comprise providing a liquid reference surface that is curved. FIG. 7 schematically illustrates a liquid reference surface in accordance with another embodiment of the present invention. FIG. 7 schematically illustrates a partial side view of a polishing station 400. The polishing station 400 comprises a platen 409 configured to support a polishing pad 407 thereon. The platen 409 has a lip 406 formed on a periphery of the platen 409. The lip 406 enables the platen 409 to retain certain amount of liquid therein. The platen 409 is coupled to a shaft 408 which further connects to rotation mechanism to rotate the substrate about a central axis of the platen 409. A sensor 401 is movably mounted over the platen 409 so that the sensor 401 may measure surface properties of a top surface of the platen 409, such as a top surface 403 of the polishing pad 407. FIG. 7 shows that the sensor 401 is mounted on a movable arm 402.

Non-planar polishing surfaces, such as concaved or convex surface, edge thin profile or edge thick profile, may be desirable in some polishing steps. The non-planar surface may be formed by using a platen having a non-planar surface and a polishing pad with even thickness, or a platen with planar surface and a polishing pad with non-planar top surface. In these situations, an ideal top surface may be non-planar and a non-planar reference surface may be desired for monitoring and calibrating the sensor 401, especially.

In one embodiment, a non-planar liquid reference surface 405 may be formed by providing a liquid 404 inside the lips 406 of the platen 409 and rotating the platen in a low speed. The centrifugal force of the rotation pulls the liquid 404 to form an edge thick profile 405 which may be similar to a non-planar surface of used in some polishing processes. In one embodiment, the rotating speed of the platen may be determined by the required feature of the reference surface 405 and the size of the platen. For example, a platen with a diameter of 30 inches may be rotated at below about 10 RPM (rotation per minute) to form an edge thick reference surface. The non-planar reference surface may be used to calibrate the sensor in the same manner as a flat liquid reference surface described earlier.

While the foregoing is directed to embodiments of the present invention, other and further embodiments of the invention may be devised without departing from the basic scope thereof, and the scope thereof is determined by the claims that follow.

What is claimed is:

1. A method for calibrating a sensor configured to measure a featured property of a target surface, the method comprising:
providing a reference surface formed from a liquid, wherein the reference surface is formed in a position approximate a measuring position of the target surface;
measuring the featured property of the reference surface using the sensor; and
calibrating the senor using the measured featured property of the reference surface.

2. The method of claim 1, wherein the sensor is an optical sensor.

3. The method of claim 1, wherein the featured property is a surface property regarding a surface profile or local profiles.

4. The method of claim 1, wherein the liquid is a light scattering liquid (304).

5. The method of claim 1, wherein the liquid is a processing solution configured for one of CMP (Chemical-Mechanical Planarization) or ECMP (Electrochemical-Mechanical Planarization) processing.

6. The method of claim 1, wherein the liquid comprises particles.

7. The method of claim 1, wherein the target surface is a polishing pad surface.

8. The method of claim 1, wherein the reference surface and the target surface are disposed on a platen alternately.

9. A method for measuring a property of a polishing pad disposed on a platen, the method comprising:
forming a liquid surface on the platen;
obtaining a reference value of the property by measuring the liquid surface using a sensor;
measuring the property of the polishing pad using the sensor; and
correcting the measured property of the polishing pad using the reference value.

10. The method of claim 9, further comprising cleaning the polishing pad by removing the liquid from the polishing pad.

11. The method of claim 9, wherein the sensor is an optical sensor.

12. The method of claim 9, wherein the property of the polishing pad and the property of the liquid surface are surface properties regarding surface profiles or local profiles.

13. The method of claim 9, wherein the liquid surface is formed from a light scattering liquid.

14. The method of claim 9, wherein the liquid surface is formed from a liquid processing solution.

15. The method of claim 9, wherein the liquid surface is formed from a liquid comprising particles.

16. The method of claim 9, wherein the liquid surface and the polishing pad are disposed on a platen alternately.

17. The method of claim 9, wherein the polishing pad is a CMP polishing pad.

18. The method of claim 9, wherein the polishing pad is configured to perform ECMP.

19. A method for processing a semiconductor substrate, comprising:
providing a platen configured to support a polishing pad thereon;
providing a sensor disposed above the platen and configured to measure a surface feature of the polishing pad on the platen;
forming a liquid surface on the platen;
measuring the surface feature of the liquid surface using the sensor; and
calibrating the sensor using the measured surface of the liquid surface.

20. The method of 19, wherein forming a liquid surface on the platen comprises immersing the polishing pad disposed on the platen with a liquid.
